(19) United States
(12) Patent Application Publication
(10) Pub. No.: US 2014/0317264 A1
(43) Pub. Date: Oct. 23, 2014

(54) SYSTEM AND METHOD FOR DETERMINING WHETHER A COMPUTER DEVICE IS COMPATIBLE WITH A COMPUTER NETWORK

(71) Applicant: APPSENSE LIMITED, Warrington (GB)

(72) Inventors: Mittal M. PAREKH, Fremont, CA (US); Joseph SAIB, Santa Clara, CA (US)

(73) Assignee: APPSENSE LIMITED, Warrington (GB)

(21) Appl. No.: 13/865,895

(22) Filed: Apr. 18, 2013

(51) Int. Cl. H04L 12/26

(52) U.S. Cl. CPC H04L 43/04
USPC 709/224

(57) ABSTRACT

A system and method are provided for allowing an administrator to automatically determine whether networked computer devices are configured to use governance software that allocates resource in, or controls or restricts the access of other network devices, to certain portions of the networked storage based upon IT governance protocols, network efficiency and economics. To do this, a company server having governance software stored thereon polls a range of device addresses (e.g., IP addresses) specified by the network administrator or stored on a DNS server with a message formatted using protocols such as WebDAV, SMB/CIFS, FTP, etc., and specific to the governance software. If the device responds to the message, the address of the device, along with an indicia that the device is compatible with the governance software is stored in memory.

### FIELD OF INVENTION

The invention relates generally to controlling access to networked storage and more particularly to a system, method, and computer program product for automatically determining whether a networked device is compatible with a computer network.

### BACKGROUND OF THE INVENTION

Computer users are creating ever increasing volumes of data files, which can easily overwhelm the memory of each user's computer. To ease the burden on user computer memory, these data files are often stored in and retrieved from remote or networked storage (e.g., a file server), identified to the computer by the address assigned to the remote or networked storage. In a typical computer network, a network administrator or a domain name system (“DNS”) server may assign each network device (e.g., computer, server, networked storage, etc.) a unique address that identifies the device. This address is used by the network device to communicate with other network devices.

To control access to the remote or networked storage, a governance software may be installed on an application server, such as the Datallow™ software sold by AppSense™, to allocate resource in, or control or restrict the access of other network devices to, certain portions of the networked storage based upon IT governance protocols, network efficiency and economics. For example, each user device accessing the network may be assigned an identifier or name. This identifier may be used by the application server to determine the user's level of access to the remote or networked storage for file synchronization or storage. In this way, a system administrator can control access to protected company storage by the various networked devices using the governance software. However, to implement this system, the network administrator must identify to the governance software the identifier for each networked device (e.g., so the network knows the permission level of the device to permit access to the remote or networked storage). To identify each of the devices to the governance software, the administrator must manually program the device name (or identity) into the software program operating the governance software. This makes the deployment of the software time intensive, prone to error, and may prevent the proper deployment of the governance software.

A need exists, therefore, for a system, method and computer program product that solves the issues identified above.

### SUMMARY OF INVENTION

In accordance with the disclosed subject matter, a system, method and computer program product are provided for automatically determining whether a networked device is compatible with a governance software.

Embodiments of the invention include a system for determining whether a network device is compatible with governance software. The system comprises a computer having a processor and a tangible, non-transitory computer memory with instructions operable therein for performing on the processor a process of determining whether a network device is compatible with governance software and a process of storing a list of network devices compatible with the governance software. The instructions may comprise the steps of creating an address list comprising an address for each of the network devices connected to a computer network; polling the network device associated with each of the addresses on the address list by transmitting to the network device a message using a protocol unique to the governance software; responsive to the polling, determining whether the network device is compatible with the governance software; and responsive to determining that the network device is compatible with the governance software, storing an indicia that the network device is compatible with the governance software and the address of the network device in a database.

Embodiments of the invention also include a computer program product operable on a computer having a tangible, non-transitory computer memory. The computer program product causes the computer to perform a process of determining whether a network device is compatible with governance software and a process of storing a list of network devices compatible with governance software. The instructions may comprise the steps of creating an address list comprising an address for each of the network devices connected to a computer network; polling the network device associated with each of the addresses on the address list by transmitting to the network device a message using a protocol unique to the governance software; responsive to the polling, determining whether the network device is compatible with the governance software; and responsive to determining that the network device is compatible with the governance software, storing an indicia that the network device is compatible with the governance software and the address of the network device in a database.

Embodiments of the invention also include a computer implemented method causing a computer to perform a process of determining whether a network device is compatible with governance software and a process of storing a list of network devices compatible with governance software. The instructions may comprise the steps of creating an address list comprising an address for each of the network devices connected to a computer network; polling the network device associated with each of the addresses on the address list by transmitting to the network device a message using a protocol unique to the governance software; responsive to the polling, determining whether the network device is compatible with the governance software; and responsive to determining that the network device is compatible with the governance software, storing an indicia that the network device is compatible with the governance software and the address of the network device in a database.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other effective embodiments as well.

FIG. 1 is a network diagram according to an embodiment of the invention;

FIG. 2 is an electronic block diagram of a computer server according to an embodiment of the invention;

FIG. 3 is a software block diagram for software stored on a computer server according to an embodiment of the invention;

FIGS. 4A-4B are software flow diagrams for software stored on a computer server according to embodiments of the invention;

FIG. 5 is a database for storing a the addresses of various network devices according to embodiments of the invention; and

FIG. 6 is an exemplary graphical user interface (“GUI”) for use in an embodiment of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

To address the needs discussed above, embodiments of the invention include a system for allowing a system administrator to automatically determine whether networked computer devices are configured to use governance software (e.g., Datallow™ software sold by AppSense™). Such governance software may be used to allocate resource in, or control or restrict the access of other network devices, to certain portions of the networked storage based upon IT governance protocols, network efficiency and economics. To do this, a company server having governance software stored thereon polls a range of device addresses (e.g., IP addresses) specified by the network administrator or stored on a DNS server with a message formatted using protocols such as WebDAV, SMB/CIFS, FTP, etc., and specific to the governance software. If the device responds to the message, the address of the device, along with an indicia that the device is compatible with the governance software, is stored in memory. As one skilled in the art will appreciate, the address of the device is a numerical label assigned to a particular network device such as a computer, printer, server, storage, etc., that identifies it to other network devices. If the device is configured to operate with the governance software, an indicia that the device is configured to operate with the governance software is stored in company server memory together with the address of the device.

As will be understood by those of skill in the art, the term “company server” may be one or more computers, computer servers or computer networks associated with a particular company, or organization. As such, the term “company server” is not limited to commercial companies, but may include other organizations such as education institutions, charities, non-profit groups, government entities, financial institutions, etc. Moreover, the terms “company” and “organization” should not be limited to a single entity, but can include multiple entities, corporations, organizations, charities and/or individuals having access to a secure server and database. As such, in some embodiments, the company server may be a shared server enabling one or more users to upload computer content to networked storage.

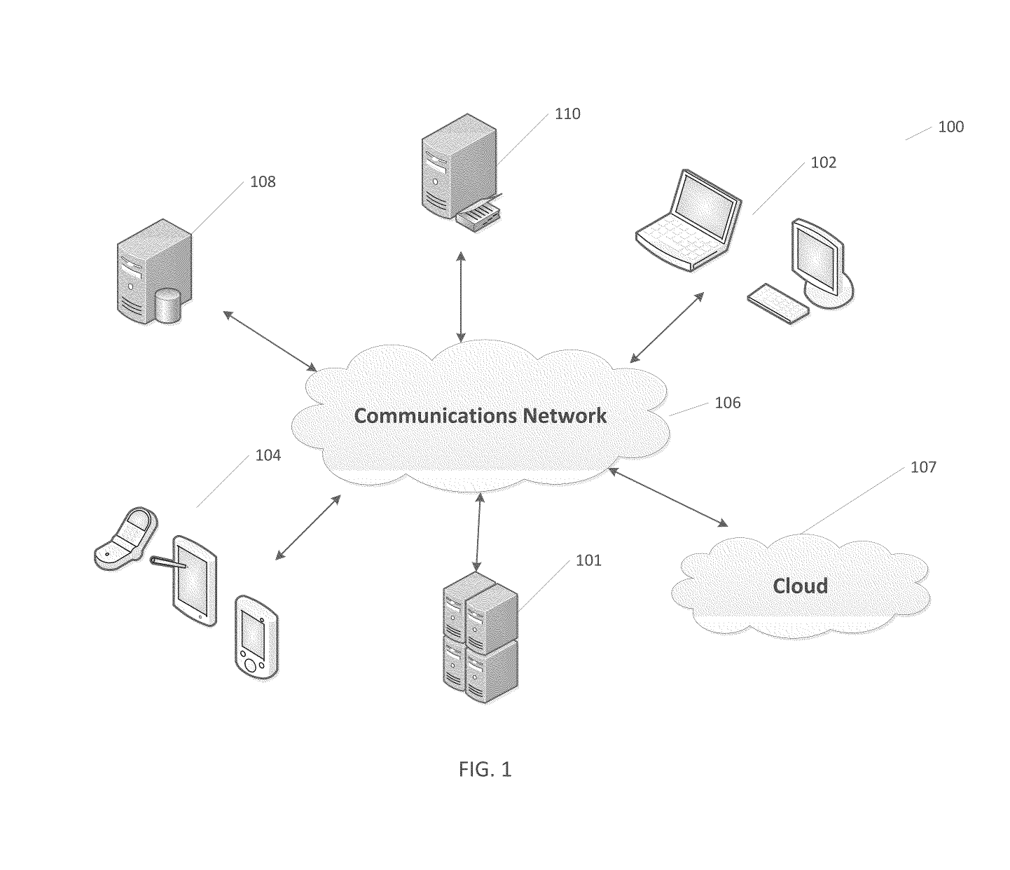

FIG. 1 is a system diagram according to embodiments of the invention. As shown, the system 100 includes a company server 101, user computers 102 (e.g., a desktop, laptop, etc.) associated with one or more users (not shown), user mobile devices 104 (e.g., a tablet, PDA, smartphone, etc.), storage 108 associated with the company server 101 and a DNS server 110. As one skilled in the art will appreciate, an implementation of system 100 may be deployed via an internal network or “intranet” with a separate connection to the internet or “cloud.” In this regard, communications network 106 is a private network that is positioned between the company server 101, the user computers 102, user mobile devices 104, and DNS server 110 to provide the user, via user computers 102 or mobile devices 104, access to the company storage 108. As will be understood by those skilled in the art, the company server may also be connected to remote storage, “in the cloud,” via a public network (e.g., the internet). The company storage 108 stores company data files that the user can access through the communications network 106 using the address of the storage device. In this regard, the DNS server 110 maintains a database of addresses for each of the devices in the network, and provides the addresses in response to queries from the company server to identify a requested device. For example, if the company server requests information from a specific device using the device name, the company server will determine whether the address for the device is stored in its local cache, and if not, request the numerical address from the DNS server. As used in embodiments of the invention, the DNS server may indicate to the company server a range of addresses for the network devices the company server can access.

As one skilled in the art will appreciate, the user computer 102 and/or user mobile device 104 can be any computing device capable of connecting to the communications network 106 and receiving data from same. As such, the user computer 102 enables the user to interact with the company server 101 to view, store and retrieve data files from storage 108. For example, the user computer 102 may be a desktop, laptop, networked computer display, computer server, WebTV, as well as any other electronic device. Similarly, mobile devices 104 may be a laptop, personal digital assistant (PDA), cellular telephone such as a Smartphone, computer tablet, etc., to also enable the user to interact with the company server 101 and remote storage 108. As such, the user computer 102 and mobile devices 104 are connected to the company server 101 via communications network 106.

As one skilled in the art will appreciate, in one embodiment, communications network 106 is comprised of a private network that may be connected to a computing cloud 107 (e.g., established over a public network such as the internet). A computing cloud can be, for example, the software implementing one or more of another company server, third party database and application that is hosted by a cloud provider and exists in the cloud. As described above, the communications network 106 can be a private network, which can include an intranet system that allows a plurality of system users to access the company server 101. For example, communications network 106 can connect all of the system components using a local area network (“LAN”) such as Ethernet or Wi-Fi, using electrical cable such as HomePNA or power line communication, optical fiber, or radio waves such as wireless LAN, to transmit data. Moreover, the term “communications network” is not limited to a single communications network system, but may also refer to several separate, individual communications networks used to connect the user computer 102 and/or user mobile device 104 to company server 101. Accordingly, though each of the user computer 102 and/or user mobile device 104 and company server 101 is depicted as connected to a single communications network, such as the internet, an implementation of the communications network 106 using a combination of communications networks is within the scope of the invention.

As one skilled in the art will appreciate, in cloud or internet implementations, the communications network 106 interfaces with the cloud 107 or internet, preferably via a firewall and web server (both not shown) to provide a secure access point for users at user computer 102 and/or user mobile device 104 and to prevent unauthorized users from accessing the various protected portions of the storage 108 in the system. The firewall may be, for example, a conventional firewall as discussed in the prior art.

Storage 108 communicates with and uploads and stores data files to the user computer 102 and/or user mobile device 104 via the company server 101 and communications network 106. As one skilled in the art will appreciate, though storage 108 is depicted as a database, storage 108 may be implemented in one or more computers, file servers and/or database servers. As such, the storage 108 may be implemented as network attached storage (NAS), storage area network (SAN), direct access storage (DAS), or any combination thereof, comprising for example multiple hard disk drives. Moreover, each of these file servers or database servers may allow a user at user computer 102 and/or user mobile device 104 to upload or download data files to the database. For example, a user may have an associated username, password, RSA code, etc., that allows the user to store or retrieve various files to storage 108. These files can be stored in one or more computers comprising the storage 108 in a plurality of software databases, tables, or fields in separate portions of the file server memory (e.g., employee records, corporate records, projects, meeting items and agendas, memos, email, letters, financial and account information, payroll records, HR records, etc.). Accordingly, as is known in the art, the computer implementing storage 108 may have stored thereon a database management system (e.g., a set of software programs that controls the organization, storage, management, and retrieval of data in the computer).

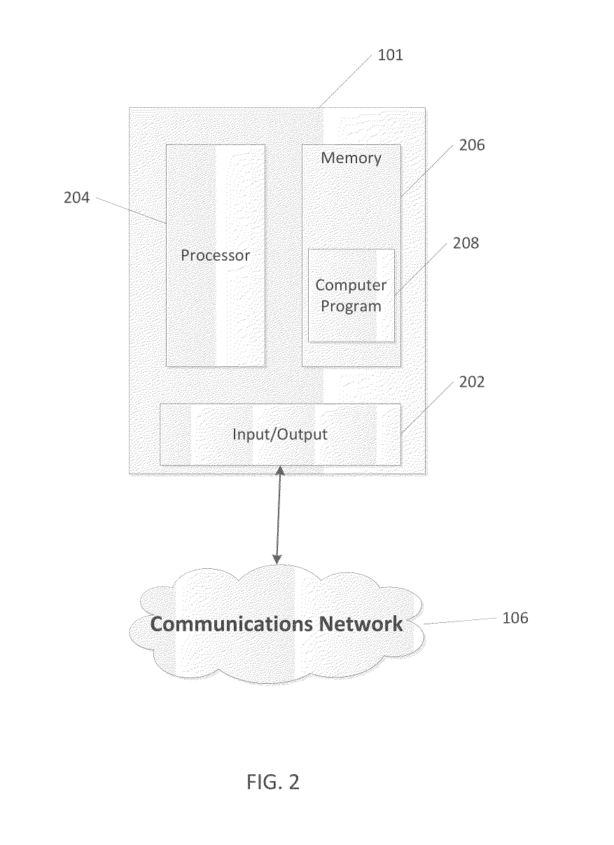

Company server 101 will now be described with reference to FIG. 2. As one skilled in the art will appreciate, company server 101 can be any type of computer such as a virtual computer, application server, or a plurality of computers (e.g., a dedicated computer server, desktop, laptop, computer tablet, WebTV, as well as any other electronic device). As such, company server 101 may comprise a memory 206, a computer program product 208, a processor 204, and an input/output (“I/O”) device 202. I/O device 202 connects the company server 101 to a signal from the communications network 106, and can be any I/O device including, but not limited to, a network card/controller connected by a bus (e.g., PCI bus) to the motherboard, or hardware built into the motherboard to connect the company server 101 to various file servers or database servers implementing storage 108.

Processor 204 is the “brains” of the company server 101, and as such executes computer program product 208 and works in conjunction with the I/O device 202 to direct data to memory 206 and to send data from memory 206 to the various file servers and communications network 106. Processor 204 can be, for example, any commercially available processor, or plurality of processors, adapted for use in company server 101 (e.g., Intel® Xeon® multicore processors, Intel® micro-architecture Nehalem, AMD Opteron™ multicore processors, etc.). As one skilled in the art will appreciate, processor 204 may also include components that allow the company server 101 to be connected to a display, keyboard, mouse, trackball, trackpad and/or any other user input/output device (not shown), that would allow, for example, an administrative user direct access to the processor 204 and memory 206.

Memory 206 may store the algorithms forming the computer instructions of the instant invention and data. Memory 206 may include both non-volatile memory such as hard disks, flash memory, optical disks, and the like, and volatile memory such as SRAM, DRAM, SDRAM, and the like, as required by embodiments of the instant invention. As one skilled in the art will appreciate, though memory 206 is depicted on, for example, the motherboard of the company server 101, memory 206 may also be a separate component or device connected to the company server 101. For example, memory 206 may be flash memory, external hard drive, or other storage.

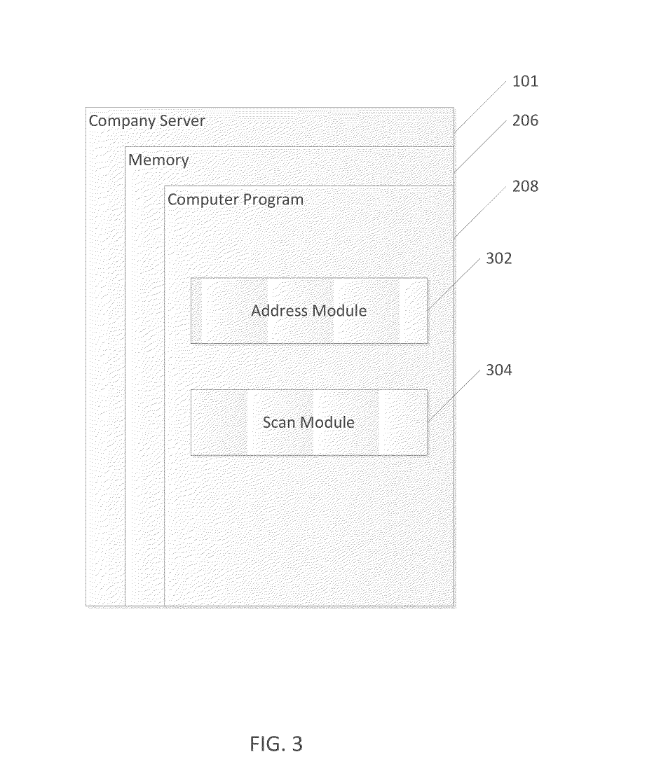

As shown in FIG. 2, an embodiment for computer instructions forming computer program product 208 implementing some of the functionality of the company server 101 is stored in memory 206 (e.g., as a plurality of programming modules). Turning now to FIG. 3, the programming modules of the computer program product 208 stored in memory 206 may include an address module 302 and a scan module 304.

The address module 302 can include instructions that enable the company server to retrieve a list of addresses for the devices connecting to the computer network. For example, an administrator may assign and a DNS server may store a plurality of IP addresses to the network devices connecting to the computer network. Each address assigned to the device may be stored by the DNS server and accessed by the instructions. In some embodiments, the administrator may determine a range of addresses to pull from the DNS server or may input a range of addresses for the scan module to poll (e.g., all or a portion of the 256 addresses associated with devices in the network as defined by addressing limitations). The scan module 304 may include instructions that allow the server to scan the addresses assigned to the devices to determine which of the devices are using the governance software described herein. For example, the scan module may send a message to each of the devices having an address on the list using a particular protocol specific to the governance software.

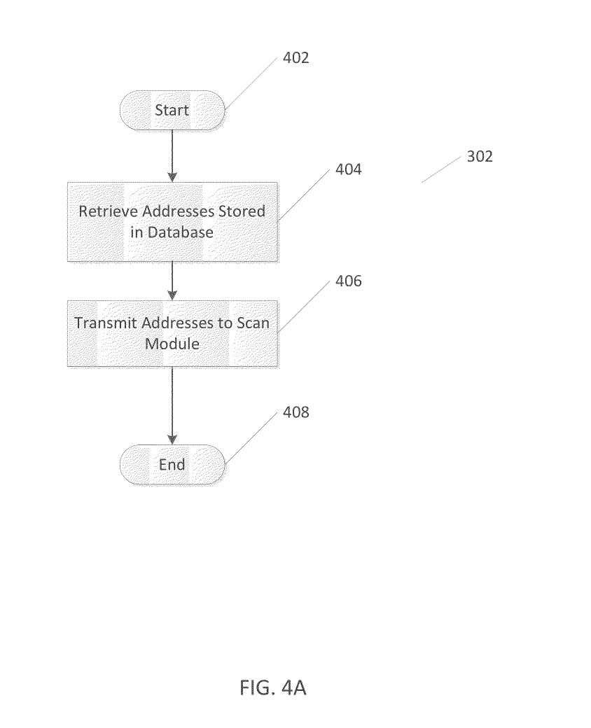

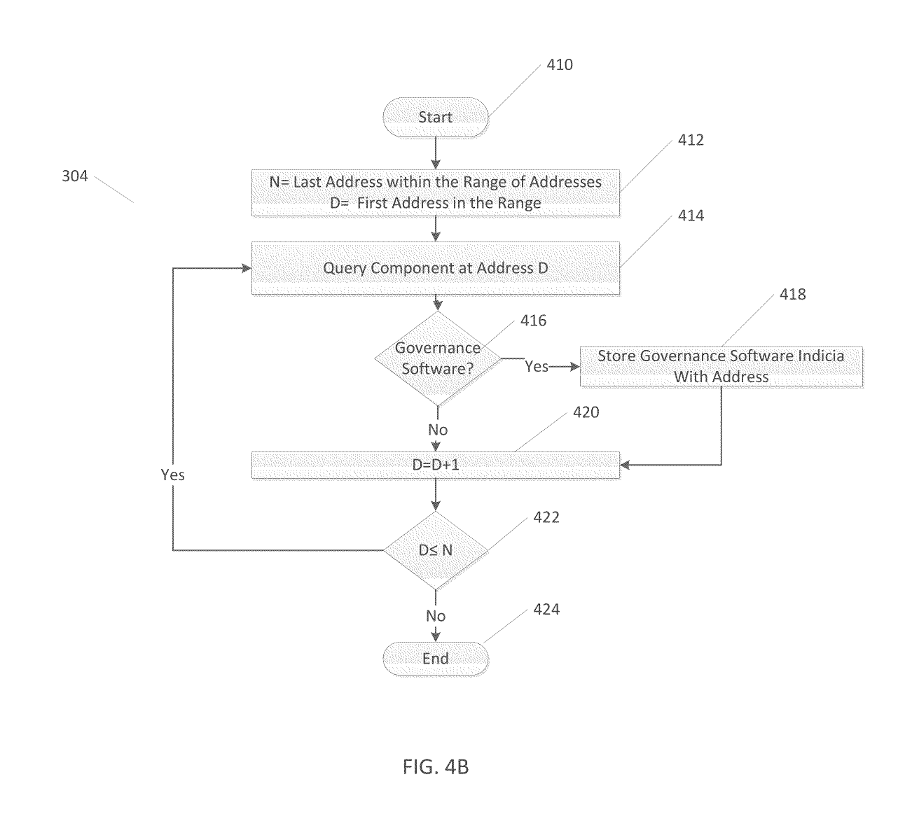

An exemplary flow diagram for the address module 302 is shown in FIG. 4A. In step 402 the process starts, and in step 404 the computer program retrieves addresses for network devices stored in the DNS server. As one skilled in the art will appreciate, in some embodiments an administrator will assign addresses to each of the network devices and the addresses will be stored in tables in the DNS server for use in the network. In other embodiments, the administrator may specify a range of addresses to poll, or a range of addresses to retrieve from the DNS server. Once the addresses are obtained, either via the specification of an address range or from the DNS server, they are transmitted to the scan module 304 (shown in FIG. 4B) in step 406. In step 408, the process ends.

Turning to FIG. 4B, the scan module 304 is described in more detail. The instruction implementing the scan module, in some embodiments, starts at step 410. In step 412, the instructions set a variable N to be the last address retrieved by the address module 302 and D as the first address in the range of addresses specified by the address module 302. As one skilled in the art may appreciate, D may also be set as a pointer to the first address value in the range of address values (e.g., the pointer is dereferenced to retrieve the value of the first address on the list). In step 414, the instructions query whether the device having the address identified by D is compatible with the governance software in step 416. For example, the software may send a message to the device using a protocol unique to the governance software. If the device understands the message, as indicated by a response from the device received by the company server 101, the device is compatible with the governance software. In such embodiments, no software or adaptors would need to be installed on the device for the instructions to determine whether the device is compatible with the governance software—the discovery of devices compatible with the software would be “automatic.” If the device is compatible with the governance software, the indicia indicating the device is compatible with the governance software is stored with the address in step 418. If it is determined that the device is not compatible with the governance software, or after the address value is stored with the indicia in step 418, the address value is advanced by one in step 420 (e.g., to the next address). In step 422 it is determined whether the address value D is the last address N. If it is not, the instructions repeat beginning with step 414. If the address value is greater than N (the last address on the list), then the process ends in step 424.

In some embodiments, only a portion of the network address may be incremented so that N is limited to 256 unique addresses (e.g., the last eight bits of the address, or 192.168.0.0 through 192.168.0.255), while in other embodiments, fewer or additional addresses can be added to the range of the query. For example, in some embodiments, the system administrator may specify multiple ranges of addresses to query, or may request certain addresses from the DNS server to be queried (e.g., network components implemented in the cloud). In such embodiments, the system and methods may construct a list of addresses to be queried by the company server, with each address representing a unique memory location. As such D may be implemented as a pointer to the memory location storing each address on the list of addresses (e.g., by dereferencing the pointer D the address stored in the memory location can be obtained).

As one skilled in the art will appreciate, the system and method do not need to retrieve the list of devices and addresses for those devices stored in the DNS server in some embodiments. In such embodiments, the system and method may query some or all of the 256 potential addresses associated with the network to determine whether any device at such addresses is operational with the governance software. Accordingly, one or more of the instructions shown in FIG. 4A may be optional.

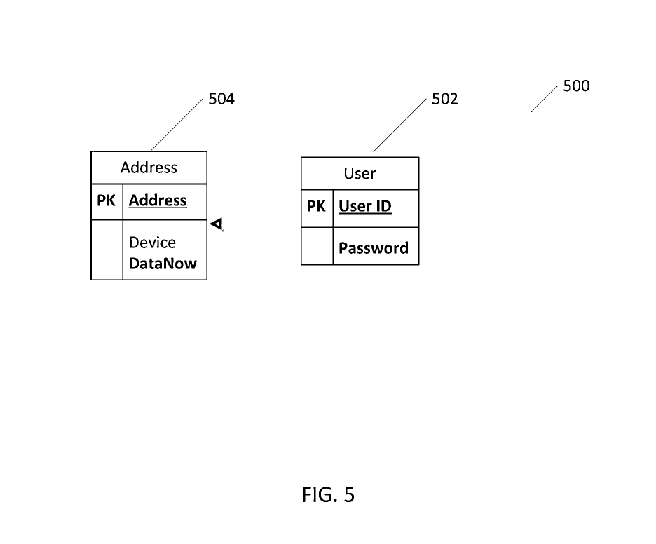

FIG. 5 describes an exemplary database 500 storing the address for the devices and the indicia indicating whether the device is using the governance software. As can be seen, a user table 502 may store user information and address table 504 may store the address for a particular device. The user table 502 includes a user ID as the primary key and the user's password as a separate column. The address table 504 includes the address of the device as the primary key, and the device and indicia as the columns. As one skilled in the art will appreciate, the two tables above are exemplary. Other tables may be added to the tables above, such as a table indicating a device name in words as opposed to numerical level, a permission level for the particular device or user, device usage statistics, etc.

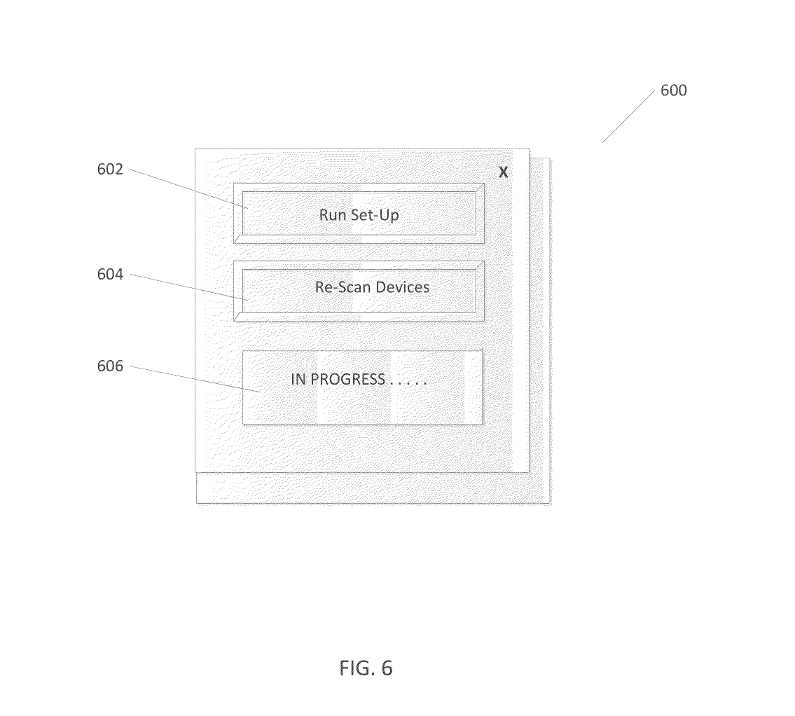

FIG. 6 shows an exemplary GUI 600 for the network administrator to use with the exemplary embodiment of the invention. Such a GUI could include a “run set-up” tab 602 to initiate the discovery of devices that operate in conjunction with the governance software, and a “re-scan devices” tab 604 that determines whether any new devices operate in conjunction with the governance software. For example, when the system administrator selects the “run set-up” tab 602 or the “rescan devices” tab 604, the computer program loads a range of addresses either selected by the system administrator or discovered from the DNS server (e.g., the range of addresses to which the company server 101 has access), and queries each of the addresses in the range with a message formatted using the protocol associated with the governance software (e.g., WebDAV, SMB/CIFS, FTP, etc.). If the device understands the message, and responds to the query, the device and device address are identified as compatible with the governance software. In some embodiments, the “re-scan devices” tab 604 may reduce the number of addresses scanned to those within the range that are not currently identified as compatible with the governance software. In such embodiments, the computer program may determine the addresses in the range that have not been identified as related to a device compatible with the governance software. The “in progress” indicia 606 may be arranged below the “run set-up” tab 602 and the “re-scan devices” tab 604 on the GUI 600. The “in progress” indicia communicates to the user the status of the scan of various network devices.

It is to be understood that the disclosed subject matter is not limited in its application to the details of construction and to the arrangements of the devices set forth in the preceding description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A system for determining whether a network device is compatible with governance software, the system comprising:
a computer having a processor and a tangible, non-transitory computer memory with instructions operable therein for performing on the processor a process of determining whether a network device is compatible with governance software and a process of storing a list of network devices compatible with the governance software, the instructions comprising the steps of:
creating an address list comprising an address for each of the network devices connected to a computer network;
polling the network device associated with each of the addresses on the address list by transmitting to the network device a message using a protocol unique to the governance software;
responsive to the polling, determining whether the network device is compatible with the governance software;
responsive to determining that the network device is compatible with the governance software, storing an indicia that the network device is compatible with the governance software and the address of the network device in a database.

2. The system of claim 1, wherein the computer memory includes the instructions that further comprise the step of:
determining a range of addresses associated with the computer network to generate the address list,
wherein the network devices include user devices and storage devices and the governance software enables the user devices to connect to the storage devices.

3. The system of claim 2, further comprising the step of:
obtaining addresses the computer has permission to access from a DNS server connected to the network,
wherein the DNS server maintains at least one table having the addresses of each network device stored therein, and
wherein the governance software restricts at least one user device from accessing at least a portion of at least one storage device.

4. The system of claim 3 wherein the database storing the address for each of the network devices and the indicia is different from the table storing the addresses in the DNS server, and
wherein the computer uses the addresses and the indicia to determine the user devices to restrict from accessing the portion of the at least one storage device.

5. The system of claim 1, wherein the memory includes instructions that further comprise the step of initiating polling the network devices in response to a query by a system administrator.

6. The system of claim 5, wherein the memory includes instructions that further comprise the step of:
determining whether an address within a range of addresses is not associated with an indicia; and
polling the network device having the addresses within the range of addresses that is not associated with indicia to determine whether the network device is compatible with the governance software.

7. The system of claim 5, wherein the memory includes instructions comprising the step of connecting a user device to a storage device using the governance software.

8. A computer program product operable on a computer having a tangible, non-transitory computer memory, the computer program product causing the computer to perform a process of determining whether a network device is compatible with governance software and a process of storing a list of network devices compatible with governance software, the instructions comprising the steps of:
creating an address list comprising an address for each of the network devices connected to a computer network;
polling the network device associated with each of the addresses on the address list by transmitting to the network device a message using a protocol unique to the governance software;
responsive to the polling, determining whether the network device is compatible with the governance software; and
responsive to determining that the network device is compatible with the governance software, storing an indicia that the network device is compatible with the governance software and the address of the network device in a database.

9. The computer program product of claim 8, wherein the memory includes instructions that further comprise the step of
determining a range of addresses associated with the computer network to generate the address list,
wherein the network devices include user devices and storage devices and the governance software enables the user devices to connect to the storage devices.

10. The computer program product of claim 8, further implementing the steps of:
obtaining addresses the computer has permission to access from a DNS server connected to the network,
wherein the DNS server maintains at least one table having the addresses of each network device stored therein, and
wherein the governance software restricts at least one user device from accessing at least a portion of at least one storage device.

11. The computer program product of claim 10, wherein the database storing the address for each of the network devices and the indicia is different from the table storing the addresses in the DNS server, and
wherein the computer uses the addresses and the indicia to determine the user devices to restrict from accessing the portion of the at least one storage device.

12. The computer program product of claim 8, wherein the memory includes instructions that further comprise the step of initiating polling the network devices in response to a query by a system administrator.

13. The computer program product of claim 12, wherein the memory includes instructions that further comprise the step of:
determining whether an address within a range of addresses is not associated with an indicia; and
polling the network device having the addresses within the range of addresses that is not associated with indicia to determine whether the network device is compatible with the governance software.

14. The computer program product of claim 12, wherein the memory includes instructions comprising the step of connecting a user device to a storage device using the governance software.

15. A computer implemented method causing a computer to perform a process of determining whether a network device is compatible with governance software and a process of storing a list of network devices compatible with governance software, the instructions comprising the steps of:
creating an address list comprising an address for each of the network devices connected to a computer network;
polling the network device associated with each of the addresses on the address list by transmitting to the network device a message using a protocol unique to the governance software;
responsive to the polling, determining whether the network device is compatible with the governance software; and
responsive to determining that the network device is compatible with the governance software, storing an indicia that the network device is compatible with the governance software and the address of the network device in a database.

16. The computer-implemented method of claim 15, further comprising the steps of:
determining a range of addresses associated with the computer network to generate the address list,
wherein the network devices include user devices and storage devices and the governance software enables the user devices to connect to the storage devices.

17. The computer-implemented method of claim 15, further comprising the steps of:
obtaining addresses the computer has permission to access from a DNS server connected to the network,
wherein the DNS server maintains at least one table having the addresses of each network device stored therein, and
wherein the governance software restricts at least one user device from accessing at least a portion of at least one storage device.

18. The computer-implemented method of claim 15, wherein the memory includes instructions that further comprise the step of initiating polling the network devices in response to a query by a system administrator.

19. The computer-implemented method of claim 15, wherein the memory includes instructions that further comprise the step of:
determining whether an address within a range of addresses is not associated with an indicia; and
polling the network device having the addresses within the range of addresses that is not associated with indicia to determine whether the network device is compatible with the governance software.

20. The computer-implemented method of claim 19, wherein the memory includes instructions comprising the step of connecting a user device to a storage device using the governance software.
